(19) United States
(12) Patent Application Publication
(10) Pub. No.: US 2007/0014612 A1
(43) Pub. Date: Jan. 18, 2007

(54) Parallel printing solution

(76) Inventor: Seong Kim, Saratoga, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/184,303

(22) Filed: Jul. 18, 2005

(51) Int. Cl. B41J 29/38

(52) U.S. Cl. 400/61

(57) ABSTRACT

An approach is provided for a parallel printing solution wherein one of a plurality of printing devices is designated a “master” device and receives print data, portions of which are then transmitted to the remainder of printing devices for processing according to instructions from the master device. According to one embodiment of the invention, a user defines certain parameters and administrative criteria at a workstation, from which the user sends print data to the master device. In one embodiment, based upon user-defined parameters and independently acquired information, the master device divides the print data into print jobs and sends the appropriate print data to the plurality of print devices for processing.

### FIELD OF THE INVENTION

This invention relates generally to printing devices, and more specifically, to an approach for parallel printing.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

The proliferation of computer technology and the growth of the Internet have greatly increased access to electronic information. Printing technology has also seen tremendous advancement in both functional variation and raw printing speed. Printing devices with higher and higher page per minute (PPM) output are constantly being introduced into the marketplace.

The disadvantage of new, faster printing technology being constantly introduced is the speed with which current technology becomes obsolete. It would be prohibitively expensive for consumers to upgrade printing devices on a regular basis. Therefore, a need exists to maximize the performance of current and older printing devices.

Once approach to the problem has been the introduction of cluster printing solutions. Cluster printing is traditionally a server-based, front-end system driving multiple output devices as if they were a single printer. There are many drawbacks to this technology. One, the architecture of current and older printing devices may not be suitable to a cluster printing environment without major modification of the devices. Two, because raster image processing (RIP) in a cluster printing environment takes place at the server level, severe data bottlenecks can hinder performance.

Other drawbacks include a lack of device resource usage, incompatibility in page description, inconsistent color management, and poor multi-copy printing performance. For example, a cluster printing environment will send the same processed print job to an output device ten times to make ten copies.

Consequently, there is a need in the art for a printing solution more suited for today's output devices that enhances system performance.

### SUMMARY

An approach is provided for a parallel printing solution wherein one of a plurality of printing devices is designated a “master” device and receives print data, portions of which are then transmitted to the remainder of printing devices for processing according to instructions from the master device. According to one embodiment of the invention, a user defines certain parameters and administrative criteria at a workstation, from which the user sends print data to the master device. In other embodiments, the parameters and administrative criteria are not user-defined and may be automatically discovered by a print device. Based upon the parameters and/or independently acquired information, the master device divides the print data into print jobs and sends the appropriate print data to the plurality of print devices for processing.

This approach allows RIP to take place at each individual print device rather than at a centralized processor. By utilizing resources at the print device level, data bottlenecks may be reduced or eliminated. Because no powerful front-end server is required, cost savings are realized and current printing resources are maximized.

### BRIEF DESCRIPTION OF THE DRAWINGS

In the figures of the accompanying drawings like reference numerals refer to similar elements.

FIG. 1 is a block diagram that depicts an arrangement for a parallel printing solution according to one embodiment of the invention.

FIG. 2 is a block diagram that depicts a device control table according to an embodiment of the invention.

FIG. 3 is a flow diagram that depicts an approach for parallel printing, according to an embodiment of the invention.

FIG. 4 is a block diagram of print data according to an embodiment of the invention.

FIG. 5 is a is a block diagram of a computer system on which embodiments of the invention may be implemented

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. ARCHITECTURE

III. DEVICE CONTROL TABLE

IV. OPERATIONAL EXAMPLE

V. IMPLEMENTATION MECHANISMS

I. Overview

An approach is provided for a parallel printing solution wherein one of a plurality of printing devices is designated a “master” device and receives print data, portions of which are then transmitted to the remainder of printing devices for processing according to instructions from the master device. According to one embodiment of the invention, a user defines certain parameters and administrative criteria at a workstation, from which the user sends print data to the master device. In one embodiment, based upon user-defined parameters and independently acquired information, the master device divides the print data into print jobs and sends the appropriate print data to the plurality of print devices for processing.

One embodiment of this approach involves configuring a master print device with parallel printing management capability. The master printing device may itself participate in processing print data and generate printed versions of an electronic document. The master printing device may also determine what portions of print data are to be processed by other print devices and instruct them accordingly.

This approaches discussed within allow RIP to take place at each individual print device rather than at a centralized processor. By utilizing resources at the print device level, data bottlenecks may be reduced or eliminated. Because no powerful front-end server is required, cost savings are realized and current printing resources are maximized.

II. Architecture

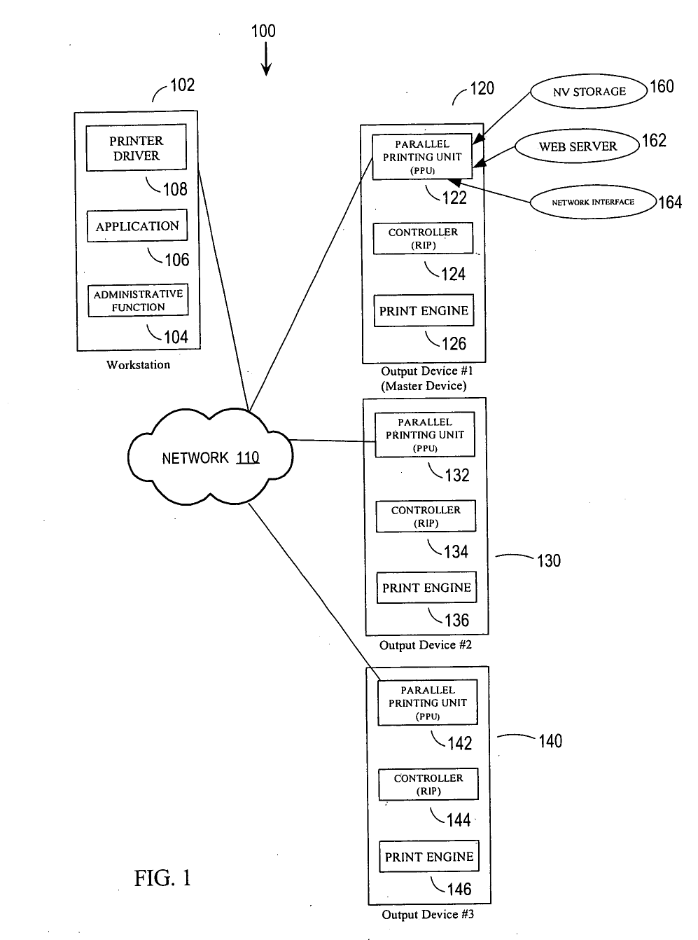

FIG. 1 is a block diagram that depicts an arrangement 100 for a parallel printing solution according to one embodiment of the invention. Arrangement 100 includes at least one workstation 102 configured with administrative functionality 104, an application 106, and a printer driver 108. Examples of workstation 102 include, without limitation, a personal computer, a personal digital assistant (PDA), or any type of mobile device. Examples of application 106 include, without limitation, a word processor, a spreadsheet program, an email client, a generic Web browser, a photo management program and a drawing or computer-aided design (CAD) program. Administrative functionality 104 includes, without limitation, capability to set or alter variables representing various portions of the parallel printing process. Workstations may be configured with fewer or more components and processes, depending upon a particular implementation, and the invention is not limited to the example depicted in FIG. 1 and described herein.

Components of the workstation 102 work in concert or separately to communicate data to one or more of a plurality of output devices 120, 130, 140. In an embodiment of the invention, the administrative functionality 104 allows a user to set parameters or otherwise configure options related to parallel printing. For example, a user could utilize the administrative functionality 104 to enable or disable parallel printing altogether. Other functions are envisioned. An application 106 is used, in one embodiment, to create data which will be transmitted to a printer driver 108. The printer driver 108 then translates the data comprising the application output into instructions readable by an output device. For example, a word processing application may be used to create a letter, data comprising the letter sent to a printer driver, and data comprising instructions for printing the letter then transmitted to an output device.

The workstation 102 is communicatively coupled to one or more output devices 120, 130, 140 via a network 110. Network 110 may be implemented by any medium or mechanism that provides for the exchange of data between workstation 102 and an output device 120, 130, 140. Examples of network 110 include, without limitation, a network such as a Local Area Network (LAN), Wide Area Network (WAN), Ethernet or the Internet, or one or more terrestrial, satellite or wireless links. Portions of network 110 may be wired connections, while other portions may be wireless connections, depending upon a particular implementation. For example, the connection between the workstation 102 and one output device 120 may be a wired connection, while the connection between the workstation 102 and another output device 130 may be a wireless connection.

Output devices 120, 130, 140 may be any device capable of printing electronic documents. Examples of output devices 120, 130, 140 include, without limitation, a printer, a copier, a facsimile and a multi-function printing device (MFP). According to one embodiment of the invention, output devices 120, 130, 140 include a parallel printing unit (PPU) 122, 132, 142, a raster image processing controller (RIP) 124, 134, 144, and a print engine 126, 136, 146. Output devices 120, 130, 140 may be configured with fewer or more components and processes, depending upon a particular implementation, and the invention is not limited to the example depicted in FIG. 1 and described herein. According to an embodiment, the PPU 122, 132, 142 is communicatively coupled to the RIP 124, 134, 144, which is further communicatively coupled to a print engine 126, 136, 146.

According to an embodiment, the PPU 122, 132, 142 is capable of receiving print and job data and executing instructions resulting in the output of one or more print jobs to separate output devices based upon the received data. According to an embodiment, the PPU 122, 132, 142 of a plurality of output devices is communicatively coupled to one or more PPUs of other output devices via a network 110. According to an embodiment, data enabling parallel printing is transmitted between PPUs of printing devices 122, 132, 142 via the network 110.

In an embodiment, one output device is designated the “master” device 120. This may be accomplished in any number of ways, such as manually, by automatic discovery, or by negotiation between devices. In an embodiment, the PPU 122 of the “master” device 120 is responsible for transmitting instructions enabling parallel printing to the remaining output devices designated by the administrative functionality 104.

In an embodiment of the invention, external devices may be communicatively coupled to one or more PPUs 122, 132, 142 in order to configure aspects of the parallel printing process or the output devices themselves. For example, instructions enabling or altering aspects of the parallel printing process may be transmitted to a PPU by way of non-volatile storage (NV) 160, data transmitted by a web server 162, or data transmitted by a network interface 164. NV storage 160 may be any type of non-volatile storage. Examples of NV storage 160 include, without limitation, non-volatile memory, such as a flash memory, an optical storage device, an electro-optical storage device and one or more hard disks. Examples of network interface 164 include, without limitation, a wired interface, such as an Ethernet card, and a wireless interface, such as an 802.x card. In one embodiment, data is transmitted to a PPU through a wireless interface of a portable computer. Examples of data transmitted by a web server 162 include, without limitation, data transmitted through a web server application such as Apache, whether on an intranet or the Internet.

III. Device Control Table

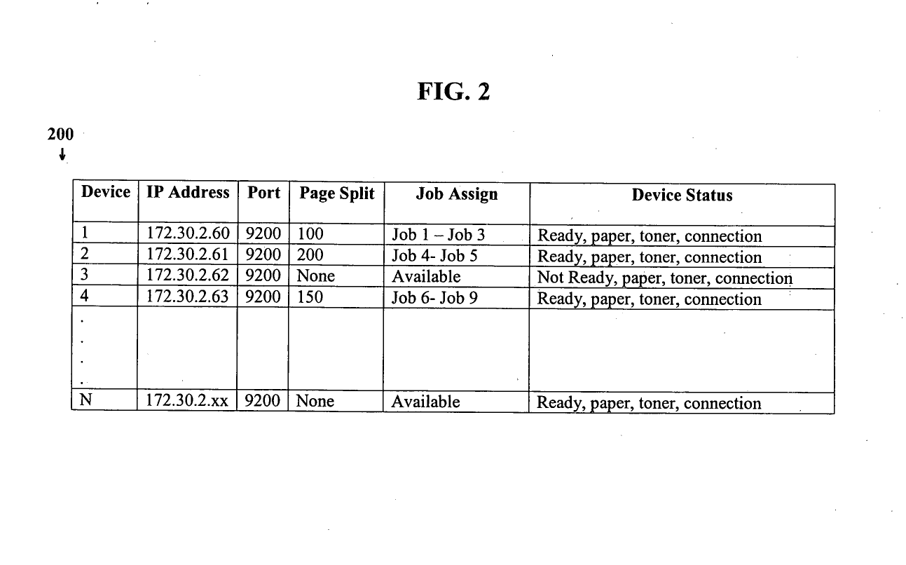

FIG. 2 is a block diagram that illustrates a Device Control Table (DCT) 200 according to one embodiment of the invention. In one embodiment of the invention, the master output device stores and maintains the DCT 200. Information to populate the DCT 200 may be user-assigned, automatically discovered by the master output device, or a combination of the two. In one embodiment of the invention, selected information in the DCT 200 is provided by a user through a web interface. This information may include, but is not limited to, IP addresses of devices to be utilized in the parallel printing process, the port number of the devices, the requested page split for the devices and the job assignment for the devices.

For example, a user may use a web-based interface within a corporate intranet to set initial values in the DCT 200. A user may input devices one, two and so forth in the device column 202. For each device, a user may input the IP address 204 of each output device currently selected to perform parallel printing in accordance with an embodiment of the invention. Information about the port 206 may be entered, as well as information related to a page range split 208.

In one embodiment of the invention, the information related to page range splitting is provided by a user to allow certain pages of a print job to be sent to a certain output device. For example, if output device #1 operates at 100 PPM and output device #2 operates at 50 PPM, a user may want 100 pages of a 150-page print job to go to output device #1 and the final 50 pages sent to output device #2 so that the jobs theoretically finish at the same time. The object of the page range split 208 is to offer user flexibility. The values for the page range split 208 may also be assigned by the master output device. For example, a user may want a page range to be sent to output device #1, but that device is out of paper. Therefore, the master device will assign a replacement value in the DCT 200.

Another value present in one embodiment of the DCT 200 is the job assignment value 210. Different types of printing jobs may be referenced. Examples include, but are not limited to, a large single print job, multiple small print jobs, and multiple copies of the same job. These common job types may be pre-assigned to certain output devices for user convenience. In other embodiments, these job types are assigned by the master output device.

Another potential value in one embodiment of the DCT is information dedicated to the status of the output devices 212. Examples of this information include, but are not limited to, device status, whether the device is loaded with paper, whether the device has adequate toner, and whether the connection with the device is active. In one embodiment, this information is dynamically collected by the master output device and updated at user-defined intervals.

In one embodiment of the invention, the PPU of the master device has the capability to poll the slave devices, interpret responses from the slave device and use the responses to populate the DCT 200. This information will be used by the master device PPU to select a designated device or alternative devices.

In one embodiment of the invention, the DCT 200 is stored as a plain text file, although other formats are envisioned. The presentation of the DCT 200 as a plain text file should not be construed as a limitation of the invention. In one embodiment, each output device is capable of storing the DCT 200 in a format readable by the PPU of the output device.

IV. Operational Example

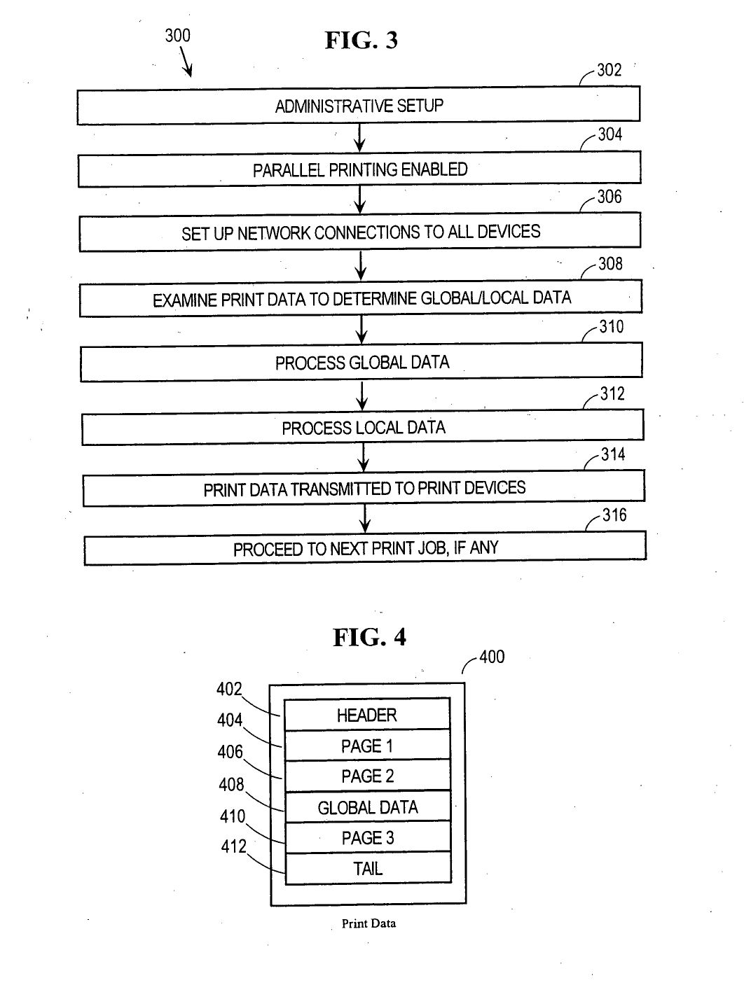

FIG. 3 is a flow diagram 300 that depicts an approach for parallel printing according to an embodiment of the invention. In step 302, a user may administer information contained within the DCT as described herein. For example, a user may enter information related to the print devices that will participate in parallel printing. In step 304, an inquiry is made regarding the enablement of parallel printing. If parallel printing is not enabled, then the print data is sent to an output device controller for conventional processing. If parallel printing is enabled, then the network connections to all devices are administered 306. In one embodiment, this process is a rediscovery of output devices to ascertain their current status. In one embodiment, data collected at this step may be used to update the DCT 200.

In step 308 a current portion of print data is analyzed and checked to identify local data portions and global data portions. In one embodiment, local data is specific to a page. Examples include, but are not limited to, fonts used on a page; graphics to be drawn on a page, such as a circle; and patterns to be used on a page, such as an 80% grayscale fill. In one embodiment, global data is common to all pages-within a print job. Examples of global data include, but are not limited to: the header portion of the current piece of data; paper type and size; grayscale versus color; collating, stapling and other printer device options; and fonts used within a print job. These types of data (global and local) are language-specific and vary in implementation. In step 310, data identified as global is processed and prepared for transmittal to all devices participating in parallel printing of a specific print job. In step 312, local data is processed and prepared for transmittal to the print device responsible for processing the specific page to which the local data relates.

In step 314, print data is transmitted to the appropriate print device. In one embodiment, this step entails further processing, such as page splitting, job splitting, and copy splitting. In one embodiment, a job splitting handler splits a large number of jobs into smaller groups. For example, print jobs 1 to 5 may be one group and jobs 6 to 9 may be a second group. In one embodiment, a copy splitting handler splits multiple copy jobs into smaller groups. For example, copies 1 to 3 may be one group and copies 4 to 6 may be a second group. In one embodiment, a page splitting handler splits a large job into several smaller jobs. For example, pages 1 to 100 in a print job may be split into one job and pages 101-200 may be split into another job.

In one embodiment, the smaller jobs split by the page splitting handler, the job splitting handler or the copy splitting handler are then transmitted to all devices designated as available for parallel printing. In step 316, an inquiry is made to determine if the print job is finished. If not, the next print job is processed.

FIG. 4 is a block diagram that illustrates a portion of print data 400 according to an embodiment of the invention. This portion of print data comprises a header 402 and a tail 412, which are global data and are transmitted to all devices participating in parallel printing of a print job. Specific page data 404, 406, 410 is transmitted to the print device responsible for processing the specific page to which the local data relates.

V. Implementation Mechanisms

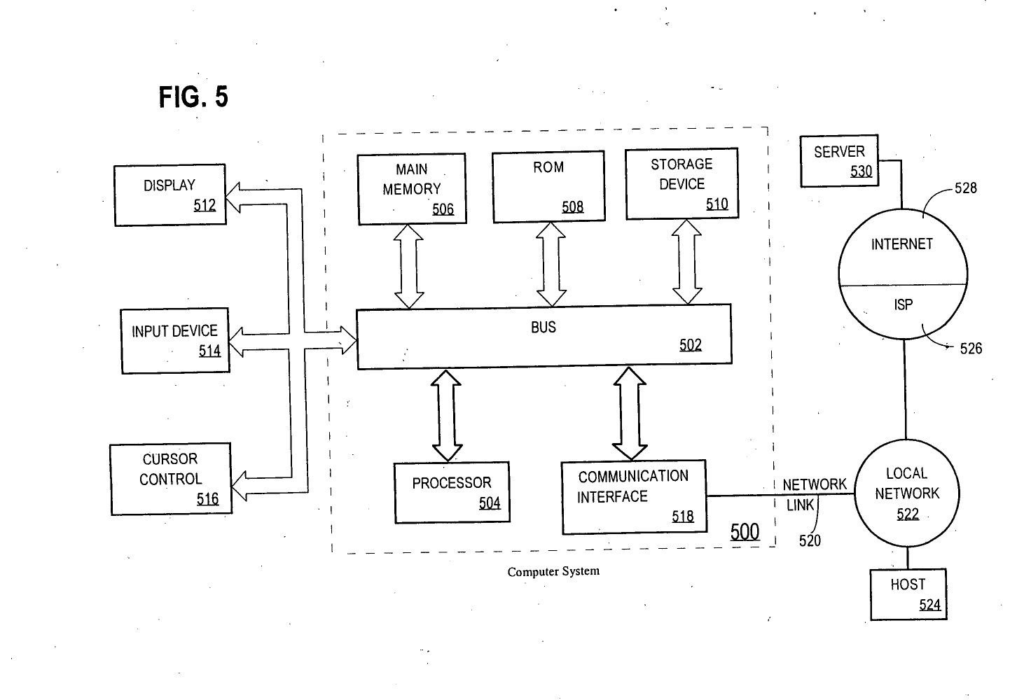

Although primarily described herein in the context of parallel printing, the approach is applicable to any type of network device or element. The approach described herein and the various elements, such as error manager 122, may be implemented in hardware, computer software or any combination of hardware and computer software on any type of computing platform. FIG. 5 is a block diagram that illustrates an example computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A printing device comprising:
a print process configured to process print data and cause a printed version of an electronic document to be generated at the printing device; and
wherein the printing device is configured to:
determine one or more other print devices that are to process at least a portion of the print data, and provide one or more portions of the print data to the one or more other print devices.

2. The printing device as recited in claim 1, wherein the print data comprises global and local data.

3. The print data as recited in claim 2, wherein the global data is provided to all the print devices.

4. The print data as recited in claim 2, wherein the local data is provided to the one or more other print devices based upon the processing to be done by the one or more other print devices.

5. The printing devices as recited in claim 1, wherein the printing device is further configured to provide one or more portions of the print data to the one or more other print devices over a network.

6. The printing devices as recited in claim 1, wherein the printing device is further configured to provide one or more portions of the print data to the one or more other print devices over a network using a secure communications protocol.

7. The printing devices as recited in claim 1, wherein the printing device is further configured to provide one or more portions of the print data to the one or more other print devices over a network using a wireless communications protocol.

8. The printing device as recited in claim 1, wherein the printing device is configured to receive over a communications network configuration data that designates the printing device as a master device.

9. The printing device as recited in claim 8, wherein the communication network is secure.

10. The printing device as recited in claim 8, wherein the communication network is wireless.

11. The printing device as recited in claim 1, wherein the print data is non-PostScript.

12. The print data as recited in claim 11, wherein the print data is in PCL version 5 or version 6 format.

13. The printing device as recited in claim 1, further comprising the use of a Device Control Table, wherein the Device Control Table contains data relating to the one or more other print devices.

14. The printing device as recited in claim 13, wherein the Device Control Table is used by the printing device to select from the one or more other print devices for the purpose of processing the print data.

15. The printing device as recited in claim 13, wherein the printing device is configured to:
receive data from the one or more other print devices, and in response to receiving the data,
update data contained by the Device Control Table.

16. The printing device as recited in claim 1, wherein the printing device is configured to execute a generic web interface.

17. The printing device as recited in claim 1, wherein the printing device is configured to:
detect that a portable media has been inserted into the printing device, and
retrieve, from the portable media, instructions related to the determining one or more other print devices that are to process at least a portion of the print data, and providing one or more portions of the print data to the one or more other print devices.
